(19) United States
(12) Patent Application Publication
(10) Pub. No.: US 2007/0172143 A1
(43) Pub. Date: Jul. 26, 2007

(54) Security system and method for operating it

(76) Inventors: Wolfgang Niem, Hildeshiem (DE); Stefan Mueller-Schneiders, Hildesheim (DE)

Correspondence Address: Striker Striker & Stenby, 103 East Neck Road, Huntington, NY, 11743, US

(21) Appl. No.: 10/587,796

(22) PCT Filed: Mar. 4, 2005
(86) PCT No.: PCT/EP05/50991

§ 371 Date: Jul. 31, 2006

(30) Foreign Application Priority Data
Apr. 16, 2004 (DE) 10 2004 018 410.0

(51) Int. Cl. G06K 9/38

(52) U.S. Cl. 382/270

(57) ABSTRACT

The invention relates to a security system 100, having a camera 3 for taking pictures of objects. From chronologically successive pictures taken by the camera 3, a gray variance [variant term] of the pixels is derived, which is compared with a threshold value that is dependent on the gray value. This improves the recognition accuracy of the security system 100.

### PRIOR ART

The invention relates to a security system as generically defined by the preamble to claim 1 and to a method for operating the security system as generically defined by the preamble to claim 4. Such security systems are often equipped with stationary cameras. Detecting movement or change with stationary cameras is a basic function of systems for radio-based security technology. The products range from surveillance cameras that issue alarms to digital video recorders which allow a content-based search for moving objects. Detecting moving objects is also a basic function in analyzing image sequences and is thus an, important component for instance of systems for man-machine interaction (such as gesture control) or biometric systems (for instance, face detection with ensuing face recognition).

Both the systems described in the scientific literature and those on the market for detecting moving objects implicitly or explicitly use a camera sensor model which assumes that the time-related noise in a pixel (“pixel noise”) is independent of the gray value. Such systems are described for instance in the following places in the literature:

A. Elgammal, D. Harwood, L. Davis, “Non-Parametric Model for Background Subtraction”, FRAME-RATE workshop, 1999.

K. Toyama, J. Krumm, B. Brumitt and B. Meyers, “Wallflower: Principles and Practice of Background Maintenance”, ICCV 1999.

A. Elgammal, R. Duraiswami, D. Harwood, L. Davis, “Background and Foreground Modeling Using Nonparametric Kernel Density Estimation for Video Surveillance”, Proc. of the IEEE, Vol. 90, No. 7, July 2002, pp. 1151-1163.

M. Meyer, M. Hotter, T. Ohmacht, “A New System for Video-Based Detection of Moving Objects and its Integration into Digital Networks”, in Proceedings of IEEE Intern. Conference on Security Technology, Lexington, USA, 1996, pp. 105-110.

T. Aach, A. Kaup, R. Mester, “Change Detection in Image Sequences using Gibbs Random Fields: A Bayesian Approach”, Proceedings Intern. Workshop on Intelligent Signal Processing and Communication Systems, Sendai, Japan, October 1993, pp. 56-61.

The assumption of gray value independent of the pixel noise in the prior art is clearly incorrect, especially in the widely used sensors employing CCD technology. Instead, in reality, an increase in the noise variance of a pixel with the corresponding gray value must be expected. The usual simplifying assumption in the industry of pixel noise independent of the gray value has an adverse effect on the performance of the entire security system. For instance, in conventional security systems this assumption means that there must be a fixed decision threshold relating to the gray value, if a distinction is to be made between a gray value change because of sensor noise and a gray value change because a moving object has been detected. However, since the noise behavior in most image sensors is gray value-dependent, this means that the aforementioned decision threshold set is too sensitive for bright image regions and too insensitive for dark image regions.

### ADVANTAGES OF THE INVENTION

The security system of the invention having the characteristics of claim 1, conversely, leads to a substantial improvement over conventional security systems. Because the decision threshold is designed to be gray value-dependent, the security system can be better adapted to both bright and dark image regions. This leads to substantially more-enhanced sensitivity of the security system. Because a gray value-dependent noise behavior is taken into account in defining the decision threshold, it is now possible even to detect dark objects in dark image regions, without generating mistaken detections caused by pixel noise in bright image regions. Advantageously, the detection precision is thus increased without causing an increase in the rate of mistaken detections. The lowest possible rate of mistaken detections, however, is of especially great significance in security technology.

### DRAWINGS

The invention is described in further detail below in conjunction with the drawings.

FIG. 1, in a graph, shows the variance of the noise value as a function of the gray value g;

FIG. 2 shows the display of the gray value-dependent noise of a CCD camera;

FIG. 3 shows one image of an image sequence that includes a plurality of images;

FIG. 4 shows one exemplary embodiment of the security system of the invention;

FIG. 5 is a flow chart; and

FIG. 6 is a further flow chart.

### DESCRIPTION OF THE EXEMPLARY EMBODIMENTS

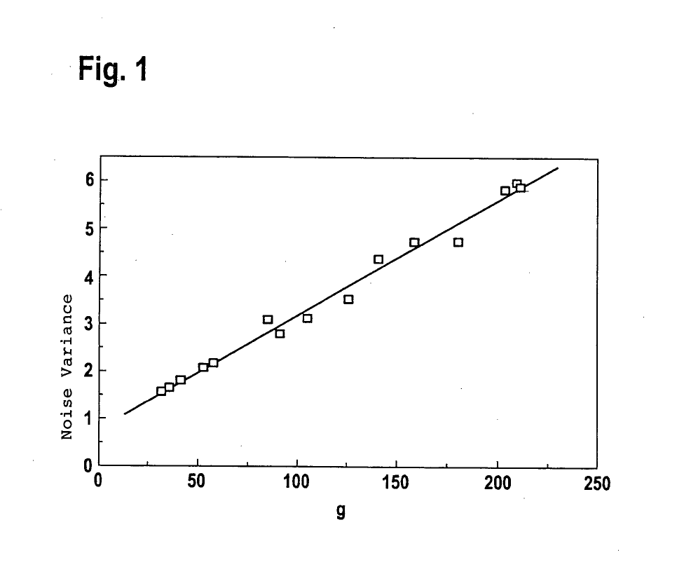

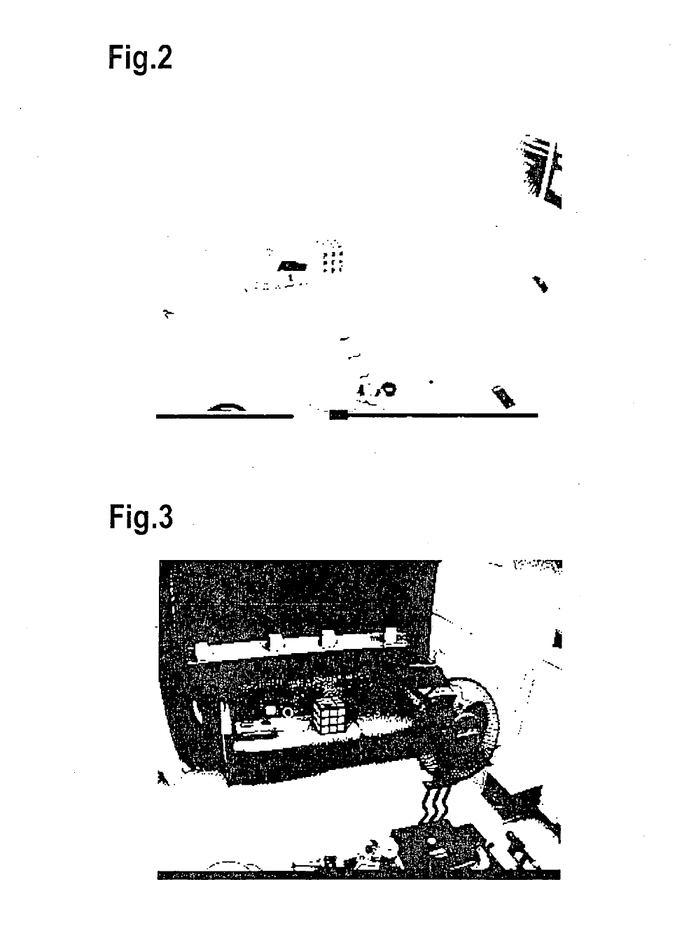

The assumption of gray value independent of the pixel noise in the prior art is clearly incorrect, especially in the widely used sensors employing CCD technology. Instead, in reality, an increase in the noise variance of a pixel with the corresponding gray value must be expected. The usual simplifying assumption in the industry of pixel noise independent of the gray value has an adverse effect on the performance of the entire security system. For instance, in conventional security systems this assumption means that a fixed decision threshold relating to the gray value is understood if a distinction is to be made between a gray value change because of sensor noise and a gray value change because a moving object has been detected. However, since the noise behavior in most image sensors is gray value-dependent, this means that the aforementioned decision threshold set is too sensitive for bright image regions and too insensitive for dark image regions. This situation is illustrated in FIG. 1. In the graph shown in FIG. 1, the variance of the noise value is plotted as a function of the gray value g of the kind measured for a typical CCD camera. It can be seen from the measured values that the noise variance increases essentially linearly with the gray value g. This effect is displayed in FIG. 2. FIG. 2, gray-value-coded, shows the variance of the pixel noise that would be determined by evaluating a sequence (of approximately 30 images) from a static scene. Bright pixels represent a high noise variance, and dark pixels represent a low noise variance. The image sequence itself shows the same picture content in all the images. A single image in this sequence is shown in FIG. 3.

If the noise variance were gray value-independent, then FIG. 2 would have to represent an unstructured gray area. As can be seen from this drawing, however, the noise variance depends on the gray value of the pixels in the image sequence. As a consequence of this dependency, bright objects in the image sequence (see FIG. 3) also appear bright in FIG. 2 (high noise variance). The dark areas in FIG. 2 result from overloading effects in the original sequence, or in other words sticking of pixels at a fixed gray value.

An optimal decision threshold would be gray value-dependent and would correspond in its qualitative course to the course of the curve marked “noise variance over the gray value”; that is, for dark image regions, the threshold would be lower than for bright pixels. In the case of a sensor with a linear course of this curve (see also FIG. 1), the decision threshold would also have to exhibit a linear behavior over the gray value.

The security system of the invention having the characteristics of claim 1 conversely leads to a substantial improvement over conventional security systems. The invention is based on the recognition that substantially better results can be attained if the decision threshold is adapted adaptively. Because the decision threshold is now designed to be gray value-dependent, the security system can be better adapted to both bright and dark image regions. This leads to substantially more-enhanced sensitivity of the security system. Because a gray value-dependent noise behavior is taken into account in defining the decision threshold, it is now possible even to detect dark objects in dark image regions, without generating mistaken detections caused by pixel noise in bright image regions. Advantageously, the detection precision is thus increased without causing an increase in the rate of mistaken detections. The lowest possible rate of mistaken detections, however, is of especially great significance in security technology.

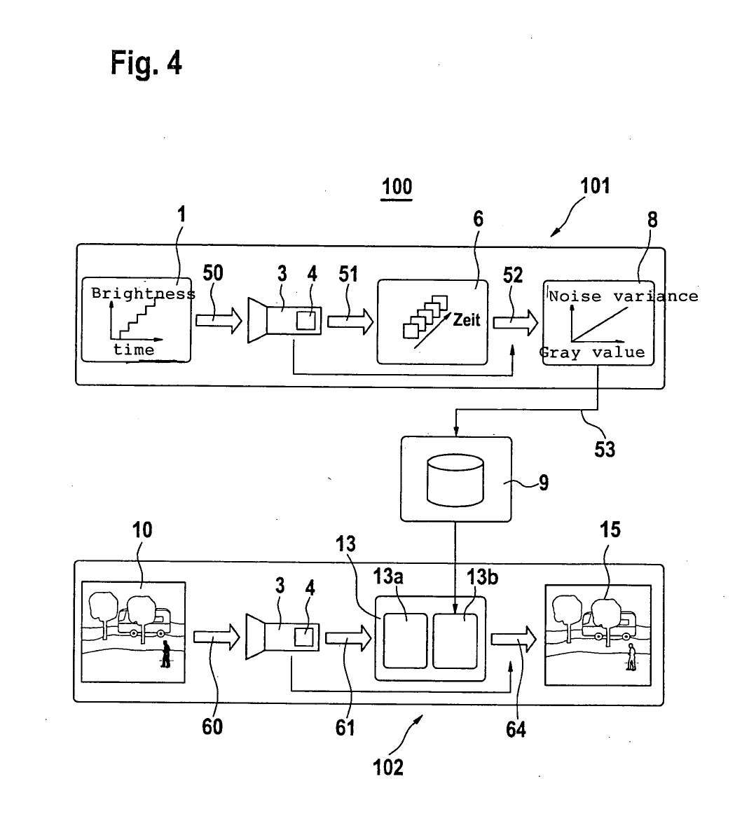

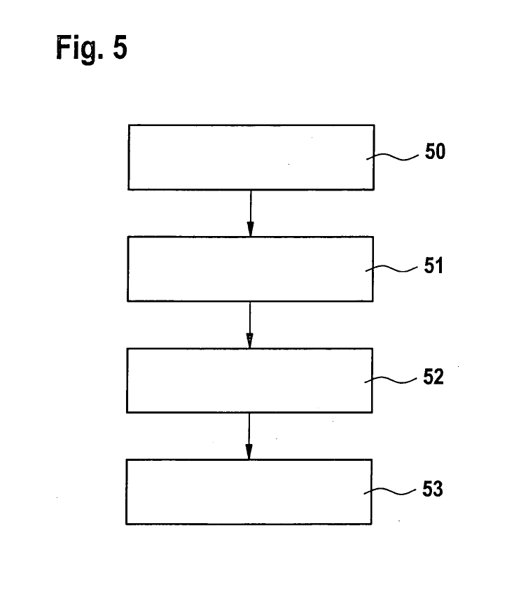

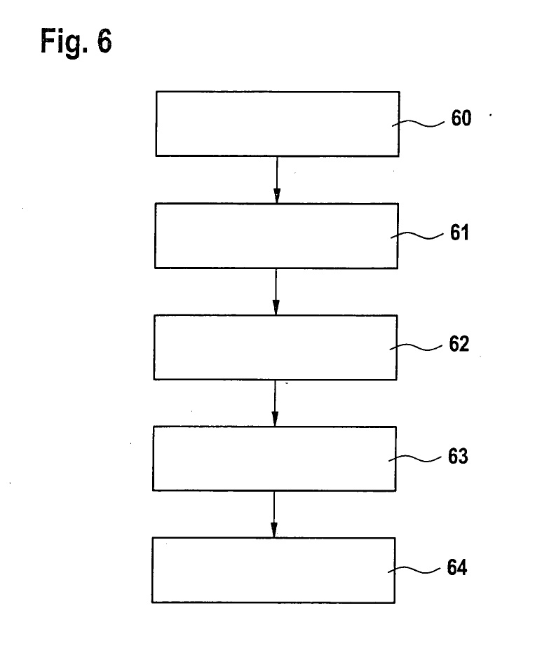

One exemplary embodiment of the security system 100 according to the invention and its operating phases will be described below, in conjunction with FIG. 4 and the flow charts shown in FIGS. 5 and 6. The security system includes two subsystems 101 and 102. The first subsystem is substantially in operation during a first operating phase, while the second subsystem is active during a second operating phase.

The security system 100 includes at least one camera 3 with an image sensor 4, and this camera is associated with both subsystems 101, 102 and is active in both operating phases of the security system 100. The security system 100 also includes a plurality of function modules 1, 6, 8, 9, 15, which are linked in terms of circuitry or at least functionally to the camera 3. The subsystem 101, besides the camera 3, includes a function module 1 with a light source. The brightness of this light source is controllable as a function of time. The subsystem 101 further includes a function module 6 for displaying a digital image sequence from the output signals of the image sensor of the camera 3. Finally, the subsystem 101 includes a function module 8 for displaying the noise variance as a function of the gray value from the digital image sequence. The subsystem 102, besides the camera 3 with the image sensor 4, includes a function module 13, which in turn comprises two function modules 13a, 13b. The function module 13a serves to calculate or estimate the gray value variance from the output signals of the image sensor 4 of the camera 3. The function module 13b makes a comparison with a threshold value possible. The security system 100 further includes a memory 9, to which both subsystems have access.

In this security system 100, two operating phases can be distinguished, which will now be discussed in succession. In the first operating phase, initialization of the security system 100 is done in the offline mode (flow chart in FIG. 5). In a second operating phase, the security system 100 takes up its security task in the online mode (flow chart in FIG. 6). In the first operating phase of the security system 100, it is essentially the subregion 101 that is active, while in the second operating phase, it is the subregion 102 that is active. Below, first, the first operating phase of the security system 100, which is shown in the subregion 101, will be explained. During the initializing phase, the noise variance is determined by a measuring system as a function of a gray value of the image sensor 4 located in the camera 3. For this purpose, a light source is furnished by the function module 1 and makes it possible to stimulate the camera 3 having the image sensor 4. The brightness of the light source in the function module 1 is increased in small increments as a function of time, and after each increase it is kept constant for a predeterminable length of time. This results in the stairstep curve, represented in the function module, for the course of the brightness. After the pickup (step 50 in FIG. 5) of the light signals generated by the function module 1 by means of the camera 3 and digitization (step 51 in FIG. 5) of the output signals of the image sensor 4 of the camera 3, a digital image sequence is then present in the function module 6, after the complete execution of the stimulation of the camera 3. The evaluation of this image sequence (step 52 in FIG. 5) in the function module 8 leads to a characteristic curve that represents the noise variance of the image sensor 4 as a function of the gray value g. This characteristic curve is stored in a memory 9 (step 53 in FIG. 5), with the image sensor 4 used being indicated, and is now available to the security system 100 for ongoing operation. The qualitative form of this curve, in particular, forms an important basis for reliable detection of an object in the area to be monitored. The shape of the characteristic curve is used to adapt the characteristic of the gray-value-dependent decision threshold adaptively accordingly. For cameras with automatic camera regulation, in an advantageous further feature of the invention, the memory 9 is additionally supplied with data which represent the dependency of the noise variance on the gray value for the various camera parameters.

The second operating phase of the security system 100 is schematically shown in the subregion 102 of the drawing. The system operates in ongoing operation as follows. A natural scene (recording field 10) that corresponds to the area being monitored is examined in terms of the scene contents for whether a change in pixels of the images taken by the camera 3 is occurring because of sensor noise, or because of a moving object. Once the natural scene 10 has been recorded (step 60 in FIG. 6) and after ensuing digitization (step 61 in FIG. 6), a digital image sequence is available, which is now analyzed by a function module 13 for the presence of moving objects, such as people, vehicles, or other things. To that end, in a function module 13a, the gray value variance is first calculated or estimated (step 62 in FIG. 6). The methods described in the literature calculate or estimate, from chronologically successive images, first the gray value variance for each pixel, which is composed additively of one component that can be ascribed to pixel noise and one component that can be ascribed to motion in the scene. If there is a significant change in a pixel that does not fit the noise model of the pixel, then on the basis of a threshold value decision in the function module 13b it is decided (step 63 in FIG. 6) that a moving object is present. The threshold value in the method of the invention is not predetermined identically for all gray values, as has conventionally been done until now but instead is adapted adaptively from the sensor characteristic curve ascertained in the function module 8 and stored in the memory 9.

In a further step (step 64 in FIG. 6), a mask is generated in order to mark a motion in the area being monitored as a segmentation result 15. The person in the right foreground is clearly apparent.

As described above, it is useful during the initializing phase for data about the operating state of the sensor 4 as well as camera parameters, such as the amplification, to be forwarded to the function module 8 that determines the noise curve, so that possible changes in the gray-value-dependent noise characteristic can be taken into account. For instance, it is possible that the amplifier noise of the image sensor 4, in low light conditions, will cover the noise in a picture element and thus change the gray-value-dependent of the noise. To make it possible to utilize this option even during ongoing operation, the operating state of the image sensor 4 must be forwarded to the function module 13b for the threshold value decision.

The essential nucleus of the invention is thus the use of an adaptive, gray-value-dependent threshold value decision for detecting objects. By this provision, the performance and precision of recognition by such a security system is enhanced substantially. The threshold values are expediently measured in advance in the form of characteristic curves as a function of the gray value and of the camera parameters and are stored in a memory 9.

1. A security system (100) having a camera (3) for taking pictures of objects, the security system (100) including at least one subsystem (101, 102), characterized in that the first subsystem (101) includes a first function module (1) with a light source whose brightness is controllable, a second function module (6) for generating a digital image sequence from pictures taken by the camera (3), and a third function module (8) for deriving the noise variance as a function of the gray value from the digital image sequence.

2. The security system as defined by claim 1, characterized in that the security system (100) includes a memory (9), in which the function values of the noise variance can be stored in memory as a function of the gray value.

3. The security system as defined by claim 1, characterized in that the second subsystem (102) includes a function module (13) for comparing a gray value variance, derived from pictures taken by the camera, with a predeterminable threshold value.

4. A method for operating a security system (100), including a camera for taking pictures of objects, characterized in that the method includes a first operating state (initializing phase) and a second operating state (operating phase).

5. The method as defined by claim 1, characterized in that in the first operating state of the security system (100), the noise variance is ascertained as a function of the gray value of an image sensor (4) located in the camera (3) and is stored in a memory (9).

6. The method as defined by claim 1, characterized in that for ascertaining the noise variance as a function of the gray value, the camera (3) including the image sensor (4) is subjected to the radiation of a light source.

7. The method as defined by claim 1, characterized in that the light source is controlled such that the brightness of the light source is increased in small increments as a function of time and then after each increase is kept constant for a predeterminable length of time, so that a kind of stairstep curve for the functional dependency of the brightness of the light source on the time is created.

8. The method as defined by claim 1, characterized in that the light source, varied in steps in its brightness, is recorded by the camera (3); that the image sensor (4) of the camera (3) converts the pictures taken into a digital image sequence; and that from this image sequence, a functional relationship representing the noise variance as a function of the gray value is derived and is stored in the memory (9).

9. The method as defined by claim 1, characterized in that in the second operating state of the security system (100), images of a region to be secured are taken by the camera (3), and these images are examined for the presence of moving objects in the region to be secured.

10. The method as defined by claim 1, characterized in that from chronologically successive pictures of the region to be secured, the gray value variance for at least selected pixels is ascertained; that if a deviation is found, a comparison with a threshold value is made, and this threshold value is predetermined variably as a function of the gray value.

11. The method as defined by claim 1, characterized in that the variable threshold value is read out from values stored in the memory (9).

12. The method as defined by claim 1, characterized in that the dependency of the noise variance on the gray value is ascertained for different parameters of the camera (3) and is stored as a function value in the memory device (9).
